(19) United States
(12) Patent Application Publication
(10) Pub. No.: US 2008/0005842 A1
(43) Pub. Date: Jan. 10, 2008

(54) Locking mechanism for a roll-in cot

(75) Inventors: Steve Schrand, Cincinnati, OH (US); Richard Habermehl JR., New Vienna, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Ferno-Washington, Inc., Wilmington, OH (US)

(21) Appl. No.: 11/825,131

(22) Filed: Jul. 3, 2007

Related U.S. Application Data
(60) Provisional application No. 60/819,412, filed on Jul. 7, 2006.

(51) Int. Cl. A61G 7/08

(52) U.S. Cl. 5/620

(57) ABSTRACT

A locking mechanism for a roll-in cot which is conveniently hand operated by the same attendant using an aft release handle used to lower the roll-in cot from its upright or elevated positions. The locking mechanism includes a stationary portion and a movable portion rotatably mounted on the stationary portion such that the movable portion is movable in a substantially vertical direction from a securing position to a release position, and vice-versa. The locking mechanism also includes a catch lever to hold the movable portion in the release position when so placed. The movable portion is biased in the securing position such that release of the aft release handle causes the movable portion to transition back into the securing position. To operate the aft release handle, the attendant must manually place the movable portion of the locking mechanism in the release position.

### CROSS-REFERENCE TO RELATED APPLICATIONS

This application claims the benefit of U.S. Provisional Application Ser. No. 60/819,412, filed Jul. 7, 2006.

### BACKGROUND OF THE INVENTION

The present invention relates generally to a locking mechanism and, in particular but not exclusively, to a locking mechanism for a roll-in cot.

Prior art roll-in cots on which to place patients typically include a number of release handles to cause the movement of extendable legs from an extended position to a collapsed position. In a typical design, such roll-in cots are provided with forward and aft release handles that are operated by a forward attendant and a rear attendant. To prevent accidental operation of the aft release handle, such as by a kicking patient, some prior art roll-in cots include a side release mechanism which must be operated by a forward attendant in order to release the aft release handle. Such an arrangement, although suitable for its intended purpose, is time consuming and somewhat awkward in its operation.

Accordingly, a locking mechanism for a roll-in cot having an aft release handle is required which is more efficiently operated and less awkward in its operation than that found in the prior art.

### SUMMARY OF THE INVENTION

The present invention addresses the above-described disadvantages, in which provided to a roll-in cot is a locking mechanism for locking the aft release handle used to lower the roll-in cot from its upright or elevated positions. The locking mechanism is conveniently hand operated by the same attendant using the aft release handle. The locking mechanism includes a stationary portion and a movable portion rotatably mounted on the stationary portion such that the movable portion is movable in a substantially vertical direction from a securing position to a release position, and vice-versa. The locking mechanism also includes a catch lever to hold the movable portion in the release position when so placed. The movable portion is biased in the securing position such that release of the aft release handle causes the movable portion to transition back into the securing position. To operate the aft release handle, the attendant must manually place the movable portion of the locking mechanism in the release position.

In one aspect of the invention provided in a first embodiment is a locking mechanism for a release handle of a roll-in cot on which a patient is to be placed. The locking mechanism is mountable on the roll-in cot and comprises a stationary portion, and a movable portion rotatable mounted on the stationary portion and adapted to rotate substantially vertically between a locking position and a release position. The locking mechanism further comprises a catch lever movable between a release position and a locking position. The catch lever is arranged such that, when the movable portion is moved from the locking position to the release position, the catch lever holds the movable portion at the release position, such that the release handle of the roll-in cot may be freely operated.

Provided in another embodiment is a locking mechanism for a release handle of a roll-in cot on which a patient is to be placed. The locking mechanism is mountable on the roll-in cot adjacent the release handle, and comprises a stationary portion and a movable portion rotatably mounted on the stationary portion. The movable portion is adapted to rotate between a locking position and a release position. The locking mechanism further includes a catch lever arranged such that, when the movable portion is moved from the locking position to the release position, the catch lever holds the movable portion at the release position, such that the release handle of the roll-in cot may be freely operated. The movable portion is also adapted to move to the locking position upon movement of the release handle to a non-operated position, thereby preventing the operation of the release handle until placing the movable portion to the release position.

In another aspect of the invention there is provided a roll-in cot for use in an ambulance. The roll-in cot comprises a frame, and forward and rear pair of legs mounted to the frame. The legs are adapted to fold under the frame permitting the cot to be rolled into the ambulance. The roll-in cot further comprises forward and aft release handles movable between a non-operated position and an operated position. Moving the forward release handle from the non-operated position to the operated position, and at the same time moving the aft release handle from the non-operated position to the operated position permits the legs to be folded under the frame. The cot further includes a locking mechanism for the aft release handle. The locking mechanism is mounted on the frame and comprises a stationary portion, a movable portion rotatable mounted on the stationary portion. The locking mechanism is adapted to rotate substantially vertically between a locking position and a release position. The locking mechanism further includes a catch lever arranged such that, when the movable portion is moved from the locking position to the release position, the catch lever holds the movable portion at the release position, such that the aft release handle may be moved to the operated position.

These and other features and objects of the present invention will be apparent in light of the description of the invention embodied herein.

### BRIEF DESCRIPTION OF THE DRAWINGS

The following detailed description of the embodiments of the present invention can be best understood when read in conjunction with the following drawings, wherein like structure is indicated with like reference numerals and in which:

FIG. 1 is a perspective view of a locking mechanism according to the present invention that has been mounted on a movable frame of a roll-in cot;

FIG. 2 is a perspective side view of the locking mechanism according to the present invention under the locking condition;

FIG. 3 is a view similar to FIG. 2, but with the locking mechanism under the locking release condition and the release handle under the non-operated condition;

FIG. 4 is a view similar to FIG. 3, but with the release handle in the operated condition;

FIG. 5 is a view similar to FIG. 4, but with the locking mechanism returning to the locking condition and the release handle returning to the non-operated condition;

FIG. 6 is a side perspective view of the locking mechanism showing the side not visible in FIGS. 1-5; and

FIG. 7 is a front perspective view of the locking mechanism showing the side not visible in FIGS. 1-6.

### DETAILED DESCRIPTION OF THE PREFERRED EMBODIMENTS

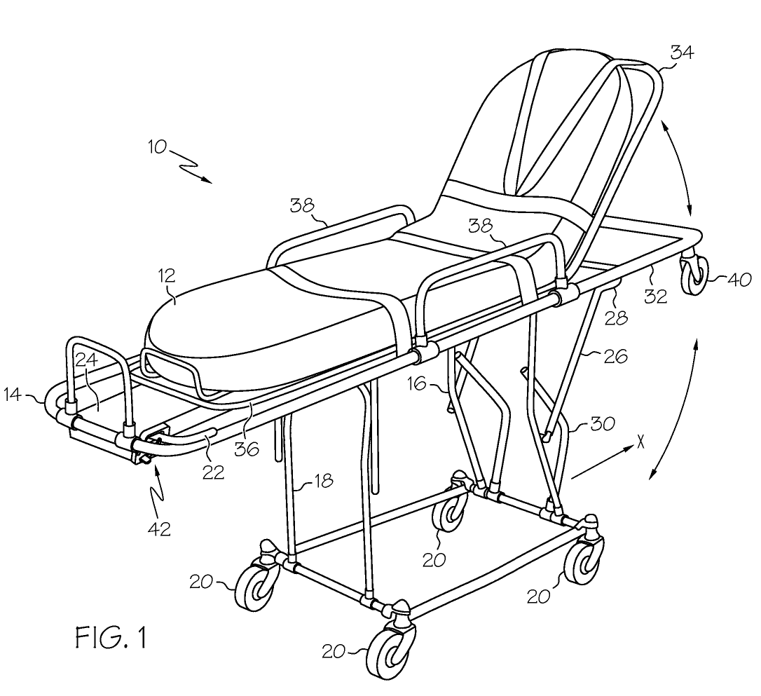

A roll-in cot 10 shown in FIG. 1 will now be described. A patient is arranged to be located on a mattress 12 supported in the region of an upper quadrilateral frame 14. The frame 14 has a forward leg frame 16 and a rearward leg frame 18 to the lower end of which wheels 20 are mounted. The wheels 20 are able to pivot about a vertical axis, which enables the cot to be easily handled and moved.

The leg frames 16 and 18 are each pivotally connected to a respective block (not shown) that are accommodated between a pair of C-channel members 24 to increase lateral stability of the cot 10. Each block is able to slide along the C-channel members 24 in the general direction of the elongate extent of the quadrilateral frame 14. In particular, ball bearings and engineering plastics reduce friction and minimize the need for lubrication of the contact between the blocks and C-channel members 24.

The leg frames 16 and 18 are connected to their blocks through respective slots (not shown) providing in the sidewalls of the C-channel member 24. Movement of the blocks are each arrested by pins (not shown) engaging in the slots, wherein moving a respective release handle to an operated position from a non-operated position clears the pins permitting movement of the respective block. The hand operated release handles are provided adjacent the forward and aft ends of the frame 12, of which aft release handle 22 is shown.

Leg frame 16 further includes a strut frame 26 pivotally connected at a point intermediate of its upper and lower extent, which in turn is mounted to the quadrilateral frame 14 at a pivot 28. Additionally, a bumper frame 30 is also pivotally mounted to leg frame 14.

The quadrilateral frame 14 may further include a fold-down head-end frame 32, which permits the overall cot length to be reduced for maneuvering. An infinitely adjustable gas-assisted backrest 34 is also pivotably attached to frame 14, and is adjustable from 0 to about 90 degrees to allow the patient to be placed in the most comfortable position during transport. Additionally, a leg rest 36 is also pivotably mounted to frame 14 to permit instant changing in the patient positioning by elevating the feet from 0 to about 45 degrees without compromising the patient's breathing. Swing-down side rails 38 are also provided to frame 14 to enable convenient patient transfer from bed to cot.

In FIG. 1, both leg frames 16 and 18 are in the fully extended position, however, it is to be appreciated that the blocks in the C-channel member 24 can be moved to and retained in different positions in the C-channel member 24 in order to achieve different operational positions for the cot. For example, the legs 18 can be pivoted slightly such that the quadrilateral frame 14 at the forward end is raised further elevating the height of a pair of loading wheels 40 above the fully extended position of the roll-in cot 10 to accommodate loading the cot into an ambulance with a transport deck above 30 inches.

To load the cot 10 into an ambulance, the cot is rolled on the wheels 20 in the direction of arrow X. A protective cover on the bumper frame 30 and strut frame 26 hits the back of the ambulance and, after manually operating a release mechanism 42 to a release position and pulling both forward and aft release handles to the operated position, the leg frames 16 and 18 are swung to a collapsed position by the abutment with the ambulance about the pivot 28. It is to be appreciated that placing the release mechanism 42 in its release position permits the aft release handle 22 to be manually operated.

Continued movement of the frame 14 into the ambulance causes the leg frames 16 and 18, strut and bumper frames 26 and 30, respectively, to collapse and extend generally parallel to the quadrilateral frame 14. At this time, the front of the trolley is supported on the ambulance floor by load wheels 40 that depend downwardly from the front of the quadrilateral frame 14. Whilst the strut 26 is moved to the collapsed position, the blocks slide forwardly within C-channel members 24 to raise the leg frames 16 and 18 upwardly and rearwardly about its pivot on their respective block. Eventually, the leg frames 16 and 18 are positioned substantially coextensive with the quadrilateral frame 14 such that wheels 20, in addition to loading wheels 40, support and guide the rear of the cot 10 on the floor of the ambulance.

Removal from an ambulance is a reversal of the insertion procedure except that the leg frames 16 and 18 return under gravity when the relevant parts clear the rear of the vehicle.

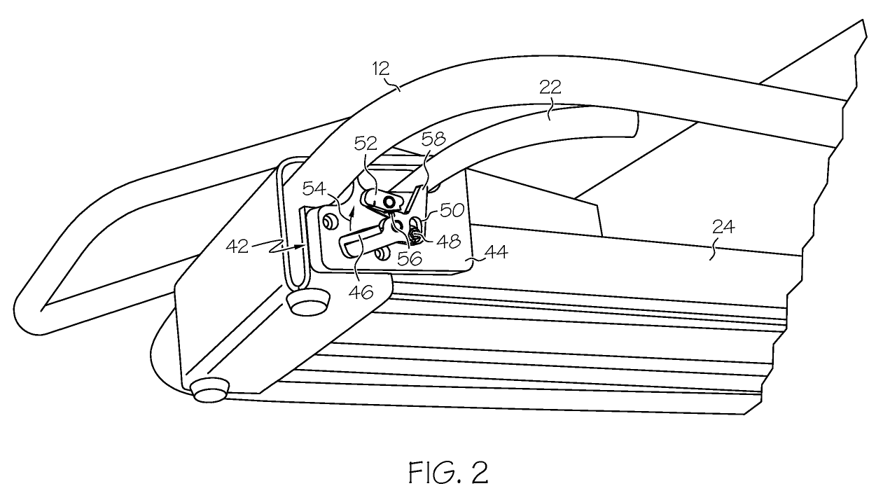

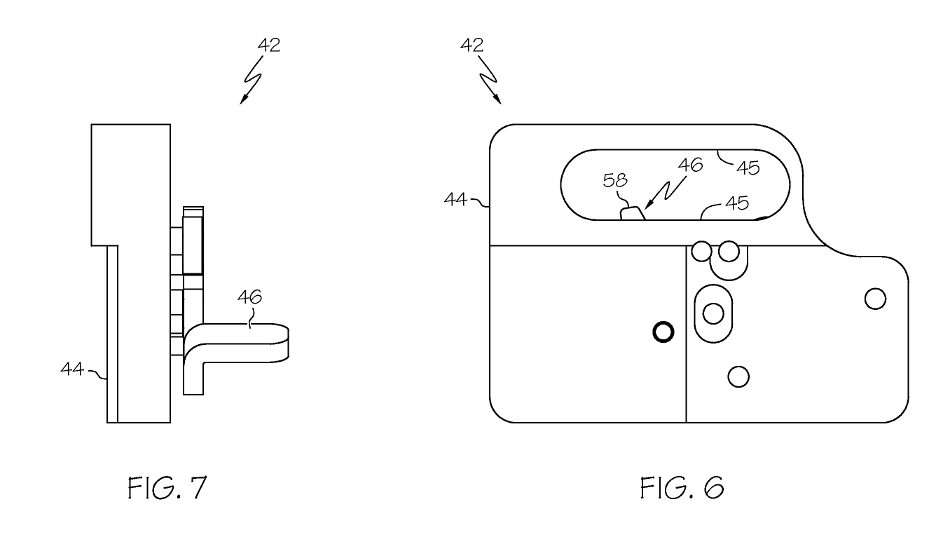

Referring now to FIGS. 2-7, the locking mechanism 42 for the aft release handle 22 of the roll-in cot 10 is shown. The locking mechanism 42 has a stationary portion or guide block 44, and a movable portion or release lever 46 rotatable mounted on the guide block 44. As illustrated, the guide block 44 is mountable to the C-channel member 24 of the frame 12 adjacent to the aft release handle 22. As best shown by FIG. 6, the guide block 44 includes a slot 45 adapted to permit the release handle 22 to extend therethrough and operate therein.

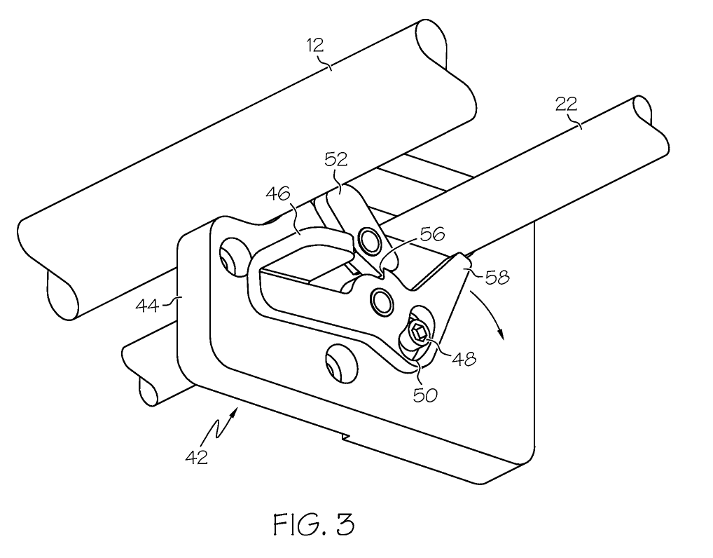

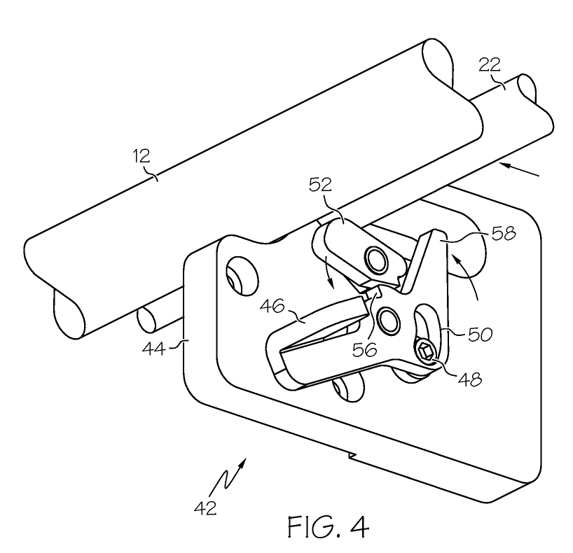

A pin 48 mounted to the guide block 44 accommodated in a slot 50 provided in the release lever 46. The function of the pin 48 is to limit movement of the release lever 46 and hold the release lever 46 in the locked position shown by FIG. 2. A spring biased catch lever 52 is also rotatably mounted to the guide block 44 and functions to position and hold the release lever 46 in the release position illustrated by FIG. 3, when the release lever is operated by moving in it in the direction of arrow 54 shown by FIG. 2. In the release position, the catch lever 52 abuts a catch portion 56 of the release lever 46 to hold the release lever in the release position. Also in the release position, a stop portion 58 clears such that the aft release handle 22 may be moved to the operated position illustrated by FIG. 4.

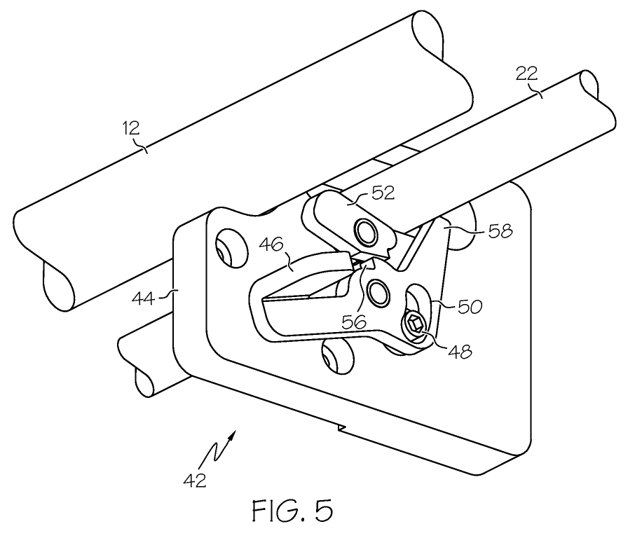

It is to be appreciated that the catch lever 52 also obstructs the movement of aft release handle 22 when the release lever 46 is in the locking position illustrated by FIG. 2, such that the release handle 22 may not be moved from its non-operated position (FIG. 2) to its operated position as illustrated by FIG. 4. When it is necessary to lower the cot 10, the locking mechanism 42 is set to the release position (FIG. 3) permitting the aft release handle 22 to transition to its operated position, as shown in FIG. 4. Since the release lever 46 is biased to its locking position (FIG. 2), movement of the aft release handle 22 from the non-operated position (FIG. 3) to the operated position (FIG. 4) causes the aft release handle 22 to encounter the catch lever 52. Continued movement of the aft release handle 22 causes the catch lever 52 to rotate from its engagement with catch portion 58, thereby permitting the release lever 46 under tension to return to its locking position as illustrated by FIG. 5.

The release lever 46 may be biased, such as for example, but not limited to, by a spring or coil connected between the release lever 46 and guide block 44. It is to be appreciated that other biasing method may be employed to cause the return of the release lever 46 to the locking position, such as fluid pressure, flexible members, and combinations thereof. Since the release handle 22 is also biased to its non-operated position (FIG. 2), releasing the release handle 22 will cause it to transition back to the non-operated position. As the release handle 22 moves back to the non-operated position, the stop portion 58 rides under the release handle 22 as shown by FIG. 5 to reposition the locking mechanism 42 once again to the locking position.

FIG. 6 is a side perspective view of the locking mechanism showing the side not visible in FIGS. 1-5; and FIG. 7 is a front perspective view of the locking mechanism showing the side not visible in FIGS. 1-6.

Although the present invention has been fully described by way of examples with reference to the accompanying drawings, it is to be noted that various changes and modifications will be apparent to those skilled in the art. Therefore, unless such changes and modifications otherwise depart from the spirit and scope of the present invention, they should be construed as being included therein.

What is claimed is:

1. A locking mechanism for a release handle of a roll-in cot on which a patient is to be placed, said locking mechanism being mountable on the roll-in cot and comprising:
a stationary portion;
a movable portion rotatably mounted on said stationary portion and adapted to rotate between a locking position and a release position; and
a catch lever arranged such that, when said movable portion is moved from the locking position to the release position, said catch lever holds said movable portion at said release position, such that the release handle of the roll-in cot may be freely operated.

2. The locking mechanism according to claim 1, wherein said catch lever is spring biased.

3. The locking mechanism according to claim 1, wherein said movable portion is biased to said locking position.

4. The locking mechanism according to claim 1, further comprises a spring mount between said movable portion and stationary portion, said spring biases said movable portion to said locking position.

5. The locking device according to claim 1, wherein said stationary portion has a slot adapted to permit the release handle to extend therethrough and to be operated therein.

6. A locking mechanism for a release handle of a roll-in cot on which a patient is to be placed, said locking mechanism being mountable on the roll-in cot adjacent the release handle, and comprising:
a stationary portion;
a movable portion rotatably mounted on said stationary portion and adapted to rotate between a locking position and a release position; and
a catch lever arranged such that when said movable portion is moved from the locking position to the release position, said catch lever holds said movable portion at said release position, such that the release handle of the roll-in cot may be freely operated, and
wherein said movable portion is adapted to move to said locking position upon movement of the release handle to a non-operated position, thereby preventing the operation of said release handle until placing said movable portion to said release position.

7. The locking mechanism according to claim 6, wherein said movable portion is biased in said locking position.

8. The locking mechanism according to claim 6, wherein said movable portion has a slot accommodating a pin mounted to said stationary portion, said slot and said pin limiting movement of said movable portion.

9. The locking mechanism according to claim 6, wherein said catch lever is rotatably mounted to said stationary portion and engages a catch portion of said movable portion.

10. The locking device according to claim 6, wherein said stationary portion has a slot adapted to permit the release handle to extend therethrough and to be operated therein.

11. The locking mechanism according to claim 6, wherein said catch lever is spring biased.

12. A roll-in cot for use in an ambulance, and comprising:
a frame;
forward and rear pair of legs mounted to said frame, said legs are adapted to fold under said frame permitting said cot to be rolled into the ambulance;
forward and aft release handles movable between a non-operated position and an operated position, such that moving said forward release handle from said non-operated position to said operated position, and at the same time moving said aft release handle from said non-operated position to said operated position permits said legs to be folded under said frame; and
a locking mechanism for said aft release handle, said locking mechanism is mounted on said frame adjacent said aft release handle and comprising:
a stationary portion,
a movable portion rotatably mounted on said stationary portion and adapted to rotate between a locking position and a release position, and
a catch lever arranged such that when movable portion is moved from the locking position to the release position, said catch lever holds said movable portion at said release position, such that said aft release handle may be moved to said operated position.

13. The roll-in cot according to claim 12, wherein said movable portion is biased in said locking position.

14. The roll-in cot according to claim 12, wherein said movable portion has a slot accommodating a pin mounted to said stationary portion, said slot and said pin limiting movement of said movable portion.

15. The roll-in cot according to claim 12, wherein said catch lever is rotatably mounted to said stationary portion and engages a catch portion of said movable portion.

16. The roll-in cot according to claim 12, wherein said stationary portion has a slot adapted to permit the release handle to extend therethrough and to be operated therein.

17. The roll-in cot according to claim 12, wherein said catch lever is spring biased.
